(19) United States
(12) Patent Application Publication
(10) Pub. No.: US 2025/0099878 A1
(43) Pub. Date: Mar. 27, 2025

(54) SYSTEM AND METHOD FOR REMOVING CONTAMINANTS FROM A PYROLYSIS FLUID

(71) Applicant: Plastic Energy Limited, London (GB)

(72) Inventors: David MCNAMARA, London (GB); Christopher STRIVENS, London (GB); Andres YABRUDY, London (GB)

(21) Appl. No.: 18/833,819

(22) PCT Filed: Jan. 24, 2023
(86) PCT No.: PCT/GB2023/050147

§ 371 Date: Jul. 26, 2024

(30) Foreign Application Priority Data
Jan. 26, 2022 (GB) 2201005.2

(51) Int. Cl. B01D 21/24; B01D 21/00; B01D 21/30; B01D 21/34; B01D 36/04; C10G 31/00

(52) U.S. Cl. CPC B01D 21/2488; B01D 21/0012; B01D 21/009; B01D 21/302; B01D 21/34; B01D 36/04; C10G 31/00

(57) ABSTRACT

A system for removing contaminants from a pyrolysis fluid is provided. The system comprises a recirculation loop; and a bleed off line. The recirculation loop comprises a quenching vessel; separation apparatus; a recirculation line; and cooling apparatus. The quenching vessel has: a first inlet for receiving a supply of pyrolysis fluid; a second inlet arranged to receive a recirculated fluid; and an outlet for expelling quenched pyrolysis fluid. The separation apparatus is for removing contaminants from the quenched pyrolysis fluid to provide a clarified flow, the separation apparatus arranged to receive quenched pyrolysis fluid from the outlet. The recirculation line is arranged to receive at least a recirculation portion of the clarified flow and recirculate the recirculation portion to the second inlet. The cooling apparatus is arranged to cool fluid in the recirculation loop. The bleed-off line is for selectively bleeding-off a bleed-off portion of the clarified flow from the recirculation loop.

### BACKGROUND

Pyrolysis units may be used to convert mixed-waste plastics into hydrocarbon liquids, such as disclosed in WO 2021 123822 A1, WO 2016 030460 A1, and WO 2011 077419 A1. This process generates pyrolysis fluids, such as hydrocarbon vapours. These pyrolysis fluids may then be taken for further treatment. Typically, this further treatment may include one or more of a condensing/fractionating column, a knock-out vessel, and/or a direct/in-direct heat exchanger.

The mixed-waste plastics fed into this process typically contain one or more contaminants. These could include, for example, organic debris, paper, polyamides (such as nylon) and any other gaseous or liquid contaminants, as well as carbonaceous solids. These contaminants may be in the form of multi-component, complex asphaltenes, tars and gums. The pyrolysis fluid which is subject to further treatment may have one or more of these contaminants entrained therein.

When this pyrolysis fluid with entrained contaminants is subject to condensation, these contaminants may accumulate within any process equipment, piping, in-line items, instrumentation, and even the liquid product itself. This can cause flow-stream blockage and/or instrument failure. As a result, there is a high frequency of reactive maintenance required, reduced plant availability and reduced product quality.

Removal of these contaminants is not simple as due to the mixed-plastic nature of the initial feed, these contaminants exhibit a range of densities and melting points, with both heavier components that solidify at elevated temperatures (approximately 100-160° C.) that settle quickly and lighter components that remain viscous/amorphous whilst remaining in suspension throughout the liquid condensing/handling process. The cohesive/adhesive nature of these contaminants tends to promote coating, layering and thereby make them difficult to handle.

There is therefore a need for an improved system and method for removing contaminants from a pyrolysis fluid.

### SUMMARY

A system for removing contaminants from a pyrolysis fluid is provided according to claim 1. This system allows for effective treatment of pyrolysis fluid to remove contaminants.

The system may further comprise flow control apparatus arranged to control flow through the bleed-off line such that a volumetric rate of flow through the bleed-off line is less than a volumetric rate of flow through the recirculation line. This means that the bulk of the clarified fluid is returned back to the quenching vessel for the quenching process.

The volumetric rate of flow through the bleed-off line may be at most 30% of the volumetric rate of flow through the recirculation line. Such a level of recirculation can deliver effective quenching. Alternatively, the volumetric rate of flow through the bleed-off line may be at most 20% or 10% of the volumetric rate of flow through the recirculation line

The flow control apparatus may comprises valving. Such valving can effectively control the flow through the bleed-off line.

The system may further comprise a controller arranged to control the flow control apparatus to control flow through the bleed-off line. The controller may be an electric/electronic controller, a mechanical controller, or a combination of the two.

The controller may control the flow control apparatus based on one or more of: a volumetric rate of flow into the separation apparatus; or a volume of fluid in the quenching vessel or the separation apparatus. Measuring these allows effective control of flow rates around the system.

The controller may be arranged to control the flow control apparatus to control flow through the bleed-off line such that the volumetric rate of flow through the recirculation line is substantially constant. Substantially constant may be within 5%, within 2% or within 1%. This allows for continuous operation of the system.

The system may further comprising a pump arranged to pump the quenched pyrolysis fluid from the outlet to the separation apparatus, wherein the controller is further arranged to control the pump. This controller can control the pump such that the volumetric rate of flow through the recirculation line is substantially constant. This pump can control the amount of fluid flowing from the quenching vessel and hence the flow rates through the system.

The separation apparatus may further comprise a filter between the separation apparatus and the recirculation line. Such a filter is an effective way to reduce the contaminants in the fluid. There may be a plurality of filters provided between the separation apparatus and the recirculation line.

The bleed-off line may further comprise secondary separation apparatus for filtering flow through the bleed-off line. Filtering flow in the bleed-off line can allow for removing further pyrolysis oil and/or removing other contaminants for further processing of the bleed-off portion.

The quenching vessel may comprises a condensing column or a quench column. Such columns are particularly effective for the treatment of pyrolysis fluid.

The separation apparatus may comprise a decantation vessel. A decantation vessel is an effective way to separate the quenched fluid. Denser components settle down to a lower portion of the vessel such that the quenched fluid may be separated.

The decantation vessel may further comprise an outlet, and the separation apparatus may further comprise a return line arranged to return fluid expelled from the outlet back to the decantation vessel. This effectively moves the settled material in the vessel to reduce the risk of it clogging. The outlet may be for removing fluid with a greater specific gravity than the clarified flow from the decantation vessel. That is, the outlet may be arranged in a lower portion of the decantation vessel than where clarified flow is removed.

The system may further comprise: discharge flow control apparatus arranged to control flow through the discharge line; and a discharge controller arranged to control operation of the discharge flow control apparatus based on a level of contamination of the supply of pyrolysis fluid. This allows the system to adjust based on contamination of input feed.

The system may further comprising a discharge line arranged to selectively discharge fluid expelled from the outlet to a secondary decantation vessel. This allows settled material to be extracted from the decantation vessel for further processing. The secondary decantation vessel can remove fluid with a different specific gravity compared to the first decantation vessel.

The secondary decantation vessel may further comprise an outlet, and the secondary decantation vessel may further comprise a return line arranged to return fluid expelled from the outlet back to the secondary decantation vessel. This effectively moves the settled material in the vessel to reduce the risk of it clogging. The outlet may be for removing fluid with a greater specific gravity than the wastewater from the decantation vessel. That is, the outlet may be arranged in a lower portion of the decantation vessel than where wastewater is removed.

The system may further comprise a second discharge line arranged to selectively discharge fluid expelled from the outlet to third separation apparatus arranged to receive discharged fluid for removing solids from the discharged fluid. The third separation apparatus outputs wastewater to be removed from the system.

The bleed-off line may comprise a third discharge line arranged to discharge at least a portion of the bleed-off portion to the secondary decantation vessel. This allows for further processing of the bleed-off portion. This portion of the bleed-off portion may be wastewater removed from the bleed-off portion.

The quenching vessel may be arranged to receive a plurality of fluid streams from a plurality of processes out-of-phase from one another. The system can be run continuously with new material inserted as and when it is generated. The selective use of the bleed-off line then can be used to account for the material being added. One or more of the fluid stream may be a recovered pyrolysis oil stream.

A method of removing contaminants from a pyrolysis fluid is provided according to claim 20. This method is an effective way of processing pyrolysis fluid to remove contaminants.

The method may further comprise the step of: controlling with a flow control apparatus flow into the bleed-off line such that a volumetric rate of flow through the bleed-off line is less than a volumetric rate of flow of back to the quenching vessel. This means that the bulk of the clarified fluid is returned back to the quenching vessel for the quenching process.

The method may further comprise the steps of: operating a plurality of processes out-of-phase from one another; and supplying an output of each of the processes to the quenching vessel as the one or more fluid streams. The system can be run continuously with new material inserted as and when it is generated. The selective use of the bleed-off line then can be used to account for the material being added

The steps of condensing the fluid stream, expelling the quenched pyrolysis fluid, separating the quenched pyrolysis fluid and returning the clarified flow may be performed continuously. Running these elements continuously allows for the system to easily accept new material as and when it is generated.

The quenching vessel may operate at between 40° C. and 300° C. This is an appropriate temperature for quenching processing of pyrolysis fluid originating from mixed-plastic waste.

The portion of the clarified flow may be cooled to less than 50° C. Cooled fluid this temperature can be used to quench pyrolysis fluid effectively.

The separation apparatus may be a decantation vessel and the clarified flow may be separated from the quenched pyrolysis fluid by removing fluid with a specific gravity less than a threshold. This is an effective way to separate the clarified flow from heavier material contaminants.

The threshold may be 0.9. This separates a pyrolysis oil stream from heavier contaminants.

The method may further comprise the step of continuously expelling fluid from a lower portion of the decantation vessel and returning this fluid back to the decantation vessel. The continuous recirculating of this flow helps prevent blockage due to solid accumulation.

The method may further comprise the steps of: removing fluid with a specific gravity greater than the threshold from the decantation vessel; and separating, with a secondary decantation vessel, the removed fluid to remove wastewater therefrom. The secondary decantation vessel allows for a further fluid to be separated off, such as wastewater accumulated with earlier processes.

The method may further comprise the step of continuously expelling fluid from a lower portion of the secondary decantation vessel and returning this fluid back to the decantation vessel. The continuous recirculating of this flow helps prevent blockage due to solid accumulation.

### BRIEF DESCRIPTION OF THE FIGURES

The present disclosure will make reference to the accompanying Figures in which:

FIG. 1 shows a system for removing contaminants from a pyrolysis fluid according to a first embodiment; and

FIG. 2 shows a system for removing contaminants from a pyrolysis fluid according to a second embodiment.

### DETAILED DESCRIPTION OF THE FIGURES

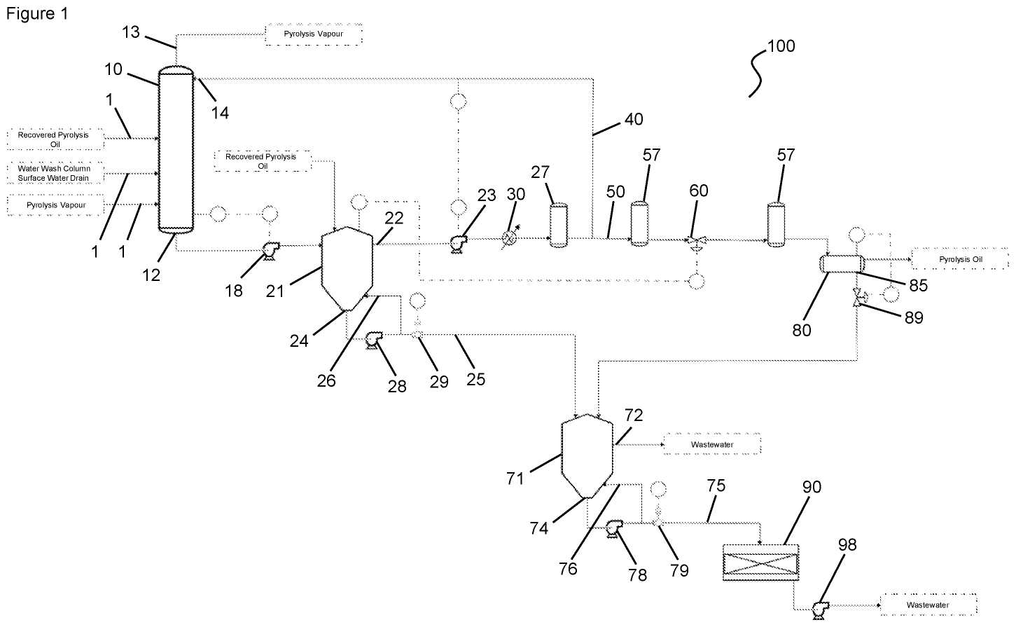

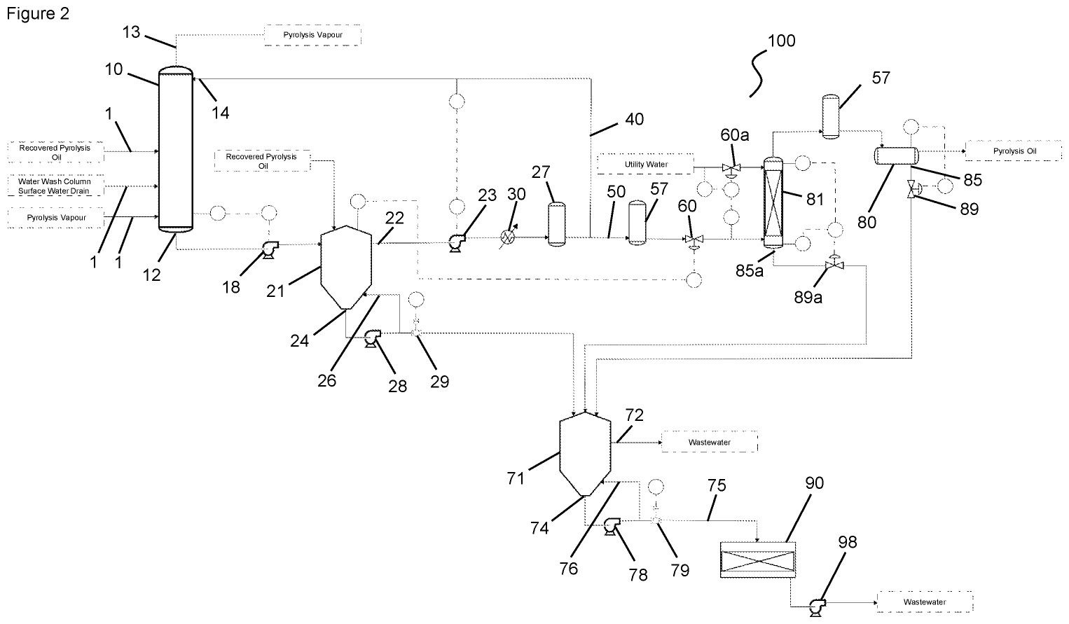

FIGS. 1 and 2 each show embodiments of a system for removing contaminants from a pyrolysis fluid. Unless expressly stated to the contrary, any feature disclosed in relation to one embodiment is equally applicable to the other embodiment. Each of FIGS. 1 and 2 show specific arrangements for a given purpose. It is appreciated that the present disclosure may be applied to any suitable process and unless otherwise specified each element of the systems shown in FIGS. 1 and 2 may be included or excluded as appropriate within the scope of the present claims.

FIG. 1 shows a system 100 for removing contaminants from a pyrolysis fluid. The system 100 includes a quenching vessel 10. This quenching vessel 10 may be a condensing or quench column. The quenching vessel 10 is used to quench an input supply of pyrolysis fluid. A first inlet 1 to the quenching vessel 10 is provided. The pyrolysis fluid is delivered to the quenching vessel 10 via this first inlet 1. As also shown in FIG. 1, one or more further fluids can also be provided to the quenching vessel. These may each be via their own separate inlet 1, or may be via a combined first inlet 1. The quenching vessel 10 may be provided with one or more of recovered pyrolysis oil, water wash column surface water drain, and pyrolysis vapour. The pyrolysis fluid may be a supersaturated pyrolysis vapour such as that originating from one or more waste-plastic pyrolysis units. This pyrolysis fluid will typically contain a number of gaseous and/or liquid contaminants (such as in the form of multi-component, complex asphaltenes, tars and gums) as well as carbonaceous solids generated in the upstream pyrolysis unit. Thus, while the term “fluid” is used throughout this specification it is understood that this will include gases, liquids and/or entrained solids.

This pyrolysis fluid may be provided from a pyrolysis system that is pyrolyzing mixed-plastic waste. Such mixed-plastic waste typically includes various contaminants which become a part of the pyrolysis fluid.

The quenching vessel 10 further comprises an outlet 12 for expelling quenched pyrolysis fluid therefrom. As shown in FIG. 1, this outlet 12 may be in a lower section of the pyrolysis vessel 10 in use. The quenching vessel 10 may be operated in use between 40° C. and 300° C. to condense condensable components of the pyrolysis fluid. Uncondensed pyrolysis vapour may exit the quenching vessel via a second outlet 13. Generally this second outlet 13 may be for non-condensables. As shown in FIG. 1 this second outlet 13 may be in an upper portion of the quenching vessel 10. This pyrolysis vapour may then be subject to further downstream processing. For example, the pyrolysis vapour may be treated with a wash column system in order to remove residual hydrocarbons to thereby form and clean a gas. Water drained from this wash column system may be provided back to the quenching vessel 10.

The quenching vessel 10 may take any suitable form and arrangement. For example, in particular embodiments the quenching vessel 10 may contain internal loose and/or fixed bed packing with high fouling resistance. This would increase the energy transfer area and hence allow the overall physical equipment size to be minimised. However, in alternatives such packing may be omitted so as to reduce the required maintenance frequency.

The outlet 12 of the vessel is for expelling quenched pyrolysis fluid. This quenched pyrolysis fluid may be pyrolysis oil. In particular examples, the quenching vessel 10 may include a conical shaped bottom head in order to promote transfer out of the quenching vessel 10 via the outlet 12.

Downstream of the outlet 12 of the quenching vessel 10 is separation apparatus. The separation apparatus may be a single component or may be formed of one or more separate elements. The separation apparatus may comprise a decantation vessel 21 such as a settling vessel. Alternatively, or additionally, the separation apparatus may comprise a filter 27. The separation apparatus is arranged to receive the quenched pyrolysis fluid from the outlet 12 of the quench vessel 10. The separation apparatus is suitable for removing contaminants from the quenched pyrolysis fluid in order to provide a clarified (or filtered) flow. This clarified flow may then be subject to further processing.

A quenching pump 18 may be provided to motivate quenched pyrolysis fluid from the quenching vessel 10 to the separation apparatus.

In particular examples, the separation apparatus is a decantation vessel 21. Such a decantation vessel 21 may be configured to separate the quenched pyrolysis fluid. For example, the decantation vessel 21 may separate the quenched pyrolysis fluid into clarified pyrolysis oil as the clarified flow and water and heavy solids such as asphaltenes, tar and pyrolysis coke as a waste.

This clarified flow may overflow from the decantation vessel 21 via outlet 22 for further treatment. In certain embodiments, a suction vessel and/or a pump 23 may be provided to extract the clarified flow from the decantation vessel 21. The pump 23 may be a low net positive suction head pump 23, which may avoid the need to use a suction vessel. Alternatively, or additionally, the relative elevation of the decantation vessel 21 and any associated pipework may be such as to meet any requirements for the pump 23.

The decantation vessel 21 may be arranged such that water and solid materials with a specific gravity above 0.9 settle at the bottom of the decantation vessel 21. That is, the decantation vessel 21 may be designed to allow fluids and solids with a specific gravity of greater than 0.9 to settle at the bottom of the vessel. Preferably, the decantation vessel 21 has a conical shape in its lower section to improve the ease of removal of this material. Clarified pyrolysis oil has a lower specific gravity than this and hence will remain at the top of the decantation vessel 21 for removal therefrom as the clarified flow.

Settled material may be removed from the decantation vessel 21 via an outlet 24. The outlet 24 may be connected to a return line 26 arranged to return fluid removed via the outlet 24 to the decantation vessel 21. This fluid may, for example, be a water and heavy solids mixture including some entrained pyrolysis oil. A pump 28, such as a pneumatic diaphragm pump, may be arranged to motivate the fluid through the return line 26. This pump 28 may run continuously to ensure a continuous flow through the return line 26. The flow may be low velocity flow. The exact flow rates and velocities will be selected based on the parameters of the system. In particular examples, the flow through the return line 26 may have a velocity of less than 1 metre/second. The flow is suitable for keeping the return line 26 and nozzles therein clear, while avoiding the mixing of solids and liquids in the decantation vessel 21. This continuous flow can help prevent blockage in the decantation vessel 21 due to solid accumulation. The pump 28 is preferentially a pneumatic diaphragm type pump. Such a pump 28 would typically require reduced maintenance time for servicing, which is particularly beneficial given the high risk of exposure to adhesive solids contamination given its purpose in the system 100.

The system 100 may further comprise a first discharge line 25 which is arranged to selectively discharge fluid from the decantation vessel 21 for further treatment as described below. That is, the first discharge line 25 may remove material from the return line 26 such that it is not returned back to the decantation vessel 21. Flow through the first discharge line 25 may be controlled with discharge flow control apparatus 29 which may, for example, include valving. The discharge flow control apparatus 29 may control flow through the first discharge line 25. That is, the discharge flow control apparatus 29 may selectively inhibit (partially or completely) flow through the first discharge line 25.

In particular embodiments, the discharge flow control apparatus 29 may be controlled by a discharge controller to periodically remove material from the return line 26. This discharge controller may, in some forms, include a timer. The timer may be electronic or mechanical. The discharge controller is preferentially adjustable to accommodate expected increases in solid loading, which may occur if mixed-waste plastic feedstock contamination increases. For example, if material is fed into the system which is more contaminated, the discharge controller may be adjusted in order to alter one or more of the frequency of removal of material and/or the length of time that the flow control apparatus 29 allows material to be removed. That is, the discharge controller arranged to control operation of the discharge flow control apparatus 29 based on a level of contamination of the supply of pyrolysis fluid to the quenching vessel 10.

Material in the separation apparatus which does not form a part of the clarified flow may be subject to further treatment steps, as described in detail below.

One or more filters 27 may also be provided as a part of the separation apparatus. In certain examples, there may be no decantation vessel 21 and the separation apparatus may just be one or more filters 27. In further examples there may be a combined quenching vessel 10 and decantation vessel 21. The filter 27 may be any suitable filter type. This could include, for example a cartridge-type filter. However, multiple filter types may be suitable and specified depending on operator preference. This filter 27 may be arranged to further filter and purify the clarified flow. For example, the filter 27 may be arranged to reduce particle load to less than 100 parts per million. In further embodiments there may be a graduated series of filters 27, each arranged to reduce the particle load to a lower level. For example, one filter 27 may be arranged to reduce the particle load to less than 50 parts per million and then a subsequent filter 27 may be arranged to reduce the particle load to less than 10 parts per million.

Cooling apparatus 30 is further provided in the system 100. While the cooling apparatus is shown between the decantation vessel 21 and filter 27 in FIG. 1 (and hence within the collective elements designated as the separation apparatus), this is not a requirement. Indeed, the cooling apparatus 30 may be provided at any suitable location within the system 100 so as to cool fluid in the system 100. In use, the cooling apparatus 30 may receive fluid, such as clarified flow, which has a temperature as high as 300° C. The cooling apparatus 30 may be configured to cool fluid it receives to less than 50° C.

In particular embodiments, the cooling apparatus 30 may be a heat exchanger. However, any suitable cooling apparatus 30 is also considered. Such a heat exchanger may be selected for an increased resistance to fouling. This may be a spiral-type heat exchanger. Such a spiral-type heat exchanger may be readily serviceable to help avoid fouling. The effect of the cooling apparatus 30 is to provide a cooled fluid. This may be, for example, a cooled clarified fluid if the cooling apparatus 30 is downstream of one or more components of the separation apparatus.

The system 100 further comprises a recirculation line 40. This recirculation line 40 is arranged to receive at least a portion of the clarified flow. The portion of the clarified flow received by the recirculation line 40 is designated as a recirculation portion. This recirculation portion of the clarified flow is then returned to the quenching vessel 10 via a second inlet 14 of the quenching vessel 10. As such, the recirculation portion of the clarified fluid is recirculated back to the quenching vessel 10. This acts as a quench recirculation stream from the quenching vessel 10. The second inlet 14 may be arranged in an upper section of the quenching vessel 10.

While the recirculation line 40 is shown in a particular position in FIG. 1, it is appreciated that this may be arranged at any suitable location in the system 100 as long as it is still able to provide the recirculation portion back to the quenching vessel 10.

Collectively, the quenching vessel 10, separation apparatus and recirculation line 40 define a recirculation loop. This recirculation loop acts to quench the input pyrolysis fluid, separate contaminants therefrom to produce a clarified flow, and return at least a portion of this clarified flow to the quenching vessel 10. The cooling apparatus 30 is arranged within this recirculation loop so as to cool fluid flowing therethrough.

The system 100 further comprises a bleed-off line 50. This bleed-off line 50 is for selectively bleeding-off at least a portion of the clarified flow from the recirculation loop. This portion is designated as a bleed-off portion. As shown in FIG. 1, the bleed-off line 50 and the recirculation line 40 may separate from one another at a three-way junction which is fed with clarified fluid. Thus, the bleed-off portion and the recirculation portion may collectively sum to the total of the clarified flow.

The system 100 may further comprise flow control apparatus 60 which is arranged to control flow through the bleed-off line 50. That is, the flow control apparatus 60 may selectively inhibit (partially or completely) flow through the bleed-off line 50. This flow control apparatus 60 may be any suitable apparatus and may, for example include valving and/or a flow restrictor. The flow control apparatus 60 may be configured to control the flow through the bleed-off line 50 based on volumetric flow rates (also known as volumetric rate of flow) of fluid through the system 100. Particularly, the flow control apparatus 60 may control flow through the bleed-off line 50 such that a volumetric rate of flow of fluid through the bleed-off line 50 is less than a volumetric rate of flow of fluid through the recirculation line 40. That is, the bleed-off portion of clarified flow may be smaller than the recirculation portion of clarified flow. In particular examples, the volumetric rate of flow through the bleed-off line 50 may be at most 30%, 20% or 10% of the volumetric rate of flow through the recirculation line 40.

The system 100 may further comprise a controller which is configured to control the flow control apparatus 60. This controller may be an electric/electronic controller such as a processor. Alternatively, the controller may be purely mechanical such as based on mechanical flow sensors and switches. A combination of electric/electronic controller and mechanical controller is also possible.

This controller may control the flow control apparatus 60 based on other conditions of the system 100. For example, the controller may be configured to determine a volume of fluid in the quenching vessel 10 and/or the separation apparatus, particularly the decantation vessel 21. Alternatively, or additionally, the controller may be configured to determine a volumetric rate of flow of fluid through any part of the system 100, such as into the separation apparatus or out of the quenching vessel 10. This may particularly be the volumetric rate of flow into the decantation vessel 21. The flow control apparatus 60 may be controlled by the controller to adjust the volume and/or volumetric flow rate of the bleed-off portion based on these measured conditions. While the measurements may be based on digital sensors and signals, equally this could be achieved purely mechanically such as via float switches and/or mechanical flow rate sensors.

In particular embodiments, the flow control apparatus 60 may be configured to drain off excess level from the decantation vessel 21 as mass is introduced to the system 100 in the quenching vessel 10 via the first inlet 1. As mass is introduced to the system 100, the level in the decantation vessel 21 increases and once it reaches a threshold value, the flow control apparatus 60 controls flow through the bleed-off line 50 to bleed off any additional product. Accordingly, a generally flow rate of fluid through the recirculation line 40 is maintained.

In order to maintain a generally constant flow rate of fluid through the recirculation line 40, the flow control apparatus 60 may control flow through the bleed-off line 50 such that the volumetric rate of flow through the recirculation line 40 (i.e., that which is not bled-off via the bleed-off line 50) is substantially the constant. In this context, substantially constant may mean that the flow rate does not vary by more than 5%, preferably no more than 2%, most preferably by nor more than 1%.

The controller may further control operation of the quenching pump 18 and/or the suction vessel and/or the pump 23 so as to maintain this generally constant flow rate and hence volume within the recirculation loop.

The bleed-off line 50 may comprise further treatment for the bleed-off portion of the fluid. For example, this could include secondary separation apparatus. At its simplest level, this may be in the form of one or more further filters 57. These further filters 57 may be any suitable type, such as cartridge filters. In certain examples these filters 57 may be arranged in a graduated series of filters 57, each arranged to reduce the particle load to a lower level. For example, one filter 57 may be arranged to reduce the particle load to less than 50 parts per million and then a subsequent filter 57 may be arranged to reduce the particle load to less than 10 parts per million. While the flow control apparatus 60 is shown between two filters 57 in FIG. 1, it is appreciated that this is not necessarily the case and the flow control apparatus 60 may be arranged in any suitable location.

The secondary separation apparatus may further comprise a water separation system 80. This may include a cartridge water coalescer and/or a two-phase liquid-liquid separator, and/or any other water separation apparatus. This water separation system 80 may be configured to reduce the free water concentration of the bleed-off portion.

Pyrolysis oil may be extracted from the secondary separation apparatus for transfer to a downstream system. This pyrolysis oil may be re-introduced to the system 100, for example into the separation apparatus such as the decantation vessel 21 or into the quenching vessel 10. Where the pyrolysis oil is re-introduced may depend on a solid content percentage of the pyrolysis oil. For example, if the solid content of the recovered pyrolysis oil is less than (or equal to) a threshold it may be introduced to the quenching vessel 10. If the solid content of the recovered pyrolysis oil is greater than the threshold it may be reintroduced to the separation apparatus—particularly the decantation vessel 21.

The secondary separation apparatus may discharge waste fluid via a second discharge line 85. The second discharge line 85 may discharge this waste fluid to any suitable further apparatus and/or processes, including for disposal. A particular further processing system for this second discharge line 85 will be discussed in detail below. The second discharge line 85 may generally discharge accumulated wastewater from the secondary separation apparatus—particularly when a water separation system 80 is included in the secondary separation apparatus. The waste fluid discharged via the second discharge line 85 may be designated as a portion of the bleed-off portion.

Flow through the second discharge line 85 may be controlled via discharge flow control apparatus 89. This may include, for example, valving. Particularly, the discharge flow control apparatus 89 may be configured to operate in a control loop to maintain a volume of fluid in the water separation system 80. Such control may involve one or more electronic components. Alternatively, this control may be achieved purely mechanically or as a mix of electronic and mechanical control.

As discussed above, the decantation vessel 21 includes a first discharge line 25. This first discharge line 25 may discharge fluid therein to a secondary decantation vessel 71. This secondary decantation vessel 71 may be generally as described above in relation to the decantation vessel 21. This secondary decantation vessel 71 may be configured to separate water and any residual hydrocarbons from heavy solids. The secondary decantation vessel 71 may be designed to allow fluids and solids with a specific gravity of greater than 1 to settle at the bottom of the vessel.

An outlet 72 of the secondary decantation vessel 71 may be provided for fluid to overflow from the secondary decantation vessel 71 into. Particularly, this may be wastewater containing residual pyrolysis oil. This flow may or may not be pumped, depending on the specific requirements of the system. The wastewater may be subject to further treatments such as a wastewater treatment plant or downstream wastewater bulking vessel or tank. In some examples, the system 100 may comprise oil recovery equipment, such that pyrolysis oil can be recovered and returned to the quenching vessel 10 and/or the separation apparatus (particularly the decantation vessel 21). This can help to reduce yield loss. Where the pyrolysis oil is re-introduced may depend on a solid content percentage of the pyrolysis oil. For example, if the solid content of the recovered pyrolysis oil is less than (or equal to) a threshold it may be introduced to the quenching vessel 10. If the solid content of the recovered pyrolysis oil is greater than the threshold it may be reintroduced to the separation apparatus—particularly the decantation vessel 21.

The secondary decantation vessel 71 may further be supplied with material discharged via the second discharge line 85 from the secondary separation apparatus. Particularly, this may be accumulated wastewater from the water separation system 80.

At the lower end of the secondary decantation vessel 71 is a return arrangement generally the same as described in relation to the decantation vessel 21.

Settled material may be removed from the secondary decantation vessel 71 via an outlet 74. The outlet 74 may be connected to a return line 76 arranged to return fluid removed via the outlet 74 to the secondary decantation vessel 71. This fluid may, for example, be a water and heavy solids mixture including some entrained pyrolysis oil. A pump 78, such as a pneumatic diaphragm pump, may be arranged to motivate the fluid through the return line 76. This pump 78 may run continuously to ensure a continuous flow through the return line 76. The flow may be a low velocity flow. The exact flow rates and velocities will be selected based on the parameters of the system. In particular examples, the flow through the return line 76 may have a velocity of less than 1 metre/second. The flow is suitable for keeping the return line 76 and nozzles therein clear, while avoiding the mixing of solids and liquids in the decantation vessel 71. This continuous flow can help prevent blockage in the secondary decantation vessel 71 due to solid accumulation. The pump 78 is preferentially a pneumatic diaphragm type pump. Such a pump 78 would typically require reduced maintenance time for servicing, which is particularly beneficial given the high risk of exposure to adhesive solids contamination given its purpose in the system 100.

The system 100 may further comprise a third discharge line 75 which is arranged to selectively discharge fluid from the secondary decantation vessel 71 for further treatment as described below. Flow through the third discharge line 75 may be referred to as discharged fluid. That is, the third discharge line 75 may remove material from the return line 76 such that it is not returned back to the secondary decantation vessel 71. Flow through the third discharge line 75 may be controlled with discharge flow control apparatus 79 which may, for example, include valving. The discharge flow control apparatus 79 may control flow through the third discharge line 75. That is, the discharge flow control apparatus 79 may selectively inhibit (partially or completely) flow through the third discharge line 75.

In particular embodiments, the discharge flow control apparatus 79 may be controlled by a discharge controller to periodically remove material from the return line 76. This discharge controller may, in some forms, include a timer. The timer may be electronic or mechanical. The discharge controller is preferentially adjustable to accommodate expected increases in solid loading, which may occur if mixed-waste plastic feedstock contamination increases. For example, if material is fed into the system which is more contaminated, the discharge controller may be adjusted in order to alter one or more of the frequency of removal of material and/or the length of time that the flow control apparatus 29 allows material to be removed.

The third discharge line 75 may connect to third separation apparatus, such as a dewatering apparatus 90. This may be, for example a dewatering vessel which may be a mobile vessel. The dewatering vessel 90 may be combined with an internal filter membrane or media. This dewatering vessel 90 may be configured to separate heavy solids from water in the discharge line 75. In this sense, the dewatering vessel 90 removes solids from the discharged fluid of the third discharge line 75. The dewatering vessel 90 may be sized so as to minimize emptying frequency to the operator's preference. For example, the dewatering vessel 90 may be between 1 cubic metre and 35 cubic metres. Alternatively, or additionally, the dewatering vessel 90 may be limited in size to comply with local truck collection capability. This may permitting removal of the dewatering vessel 90 for onward transport to a heavy products end user.

A dewatering pump 98 may be provided to motivate wastewater from the dewatering vessel 90. The wastewater may be subject to further treatments such as a wastewater treatment plant or downstream wastewater bulking vessel or tank. In some examples, the system 100 may comprise oil recovery equipment, such that pyrolysis oil can be recovered and returned to the quenching vessel 10 and/or the separation apparatus (particularly the decantation vessel 21). This can help to reduce yield loss. Where the pyrolysis oil is re-introduced may depend on a solid content percentage of the pyrolysis oil. For example, if the solid content of the recovered pyrolysis oil is less than (or equal to) a threshold it may be introduced to the quenching vessel 10. If the solid content of the recovered pyrolysis oil is greater than the threshold it may be reintroduced to the separation apparatus—particularly the decantation vessel 21.

As noted above, the system 100 shown in FIG. 1 is merely one example of the present disclosure. Any features of this system 100 may be used in isolation as appropriate.

Turning to FIG. 2, this shows a further system 100 for removing contaminants from a pyrolysis fluid. The system 100 of FIG. 2 is generally identical to that shown in FIG. 1 and described above unless otherwise expressly stated. Particularly, any disclosure above in relation to FIG. 1 can be equally applied and/or combined with the disclosure of FIG. 2.

Specifically, but not limited to, the quenching vessel 10, separation apparatus (including decantation vessel 21), cooling apparatus 30, recirculating line 40, bleed-off line 50, flow control apparatus 60, secondary decantation vessel 71, water separation system 80 and dewatering apparatus 90, along with their associated components, may generally be as described above.

The secondary separation apparatus of the system 100 may further comprise, as shown in FIG. 2, a wash water column 81. This wash water column 81 may be configured to mix incoming bleed-off portion of the clarified flow with water. This may be utility water and/or deionised water as appropriate. This mixing can remove sedimentation from the bleed-off portion, for example to a level of less than 10 parts per million.

Preferably, the bleed-off portion enters via a lower section of the wash column 81. The wash water is preferably fed into an upper section of the wash column 81. The wash column 81 may contain loose or fixed bed packing. Such packing may promote washing efficiency and thereby allow the reduction of the physical dimensions of the wash column 81 for the same amount of sedimentation removal. The wash column 81 may comprise internal flow distribution components. The wash column 81 also may include coalescing pads which may act to promote separation of water droplets from the bleed-off portion of the clarified flow.

Wash water flow into the wash column 81 may be controlled via wash column flow control apparatus 60a. Particularly, a volumetric rate of flow of wash water into the wash column 81 may be based on a volumetric rate of flow of the bleed-off portion of the clarified flow into the wash column 81. This may be proportional based on a ratio. This ratio between the two fluids may be adjustable to accommodate expected increases in solid loading, which may occur if mixed-waste plastic feedstock contamination increases. Again, this control may be electric/electronic, mechanical, or a mix of both.

The wash column 81 may further comprise a wash column discharge line 85a for removing wastewater form the wash column 81. This wash column discharge line 85a may be arranged in a lower section of the wash column 81. Flow through this wash column discharge line 85a may be selectively controlled with wash column discharge flow control apparatus 89a. Particularly, the wash column discharge flow control apparatus 89a may control flow through the wash column discharge line 85a based on a level of bleed-off portion of clarified flow in the wash column 81, particularly a level of pyrolysis oil in the wash column 81. That is, the wash column flow control apparatus 89a may selectively inhibit (partially or completely) flow through the wash column discharge line 85a. The level of bleed-off portion of clarified flow in the wash column 81 may be measured using any suitable means and again the control may be electric/electronic, mechanical, or a mix of both.

The wash column discharge line 85a may discharge to the secondary decantation vessel 71 to be processed as described above in relation to FIG. 1.

Washed bleed-off portion of the clarified flow is extracted from the wash column 81, such as via an upper outlet, and then passed on for further processing such as described above in relation to FIG. 1. Particularly, this washed bleed-off portion may be transferred to a water separation system 80 as described above. This may be via a filter 57a arranged to reduce a particle load in the washed bleed-off portion, for example to less than 10 parts per million. The filter 57 may be any type of filter but is preferably a cartridge-type filter.

The quenching vessel 10 may be arranged to receive a plurality of fluid streams from a plurality of processes with out-of-phase duty cycles. The supply of pyrolysis fluid received via the first inlet 1 of the quenching vessel 10 may be one of these fluid streams. That is, processes which may finish at different times. Particularly, the system 100 may generally operate continuously. That is, there may be a continuous flow of fluid through the recycling loop. As material is added to the quenching vessel 10, the bleed-off line 50 is selectively used to account for this increased fluid. This means that the volume of material in the recycling loop can be generally maintained. Each fluid stream may be a recovered pyrolysis oil stream.

In such a system 100, the recirculating loop may need to be effectively “primed”. That is, there may need to be an amount of fluid already circulating in this loop before any pyrolysis fluid is introduced. Thus, the pyrolysis fluid displaces existing fluid in the primed system 100 via the bleed-off line 50 and separation apparatus discussed above.

A method for removing contaminants from a pyrolysis fluid is also provided. This method may use any of the apparatus discussed above in FIGS. 1 and 2 as appropriate.

The method comprises the step of supplying the pyrolysis fluid to a quenching vessel 10. This pyrolysis fluid is then quenched in the quenching vessel 10 to form a quenched pyrolysis fluid. The method then includes expelling the quenched pyrolysis fluid from the quenching vessel to separation apparatus. The quenching vessel 10 may operate at between 40° C. and 300° C.

The separation apparatus may be any of the separation apparatus discussed above, particularly the decantation vessel 21. When the separation apparatus is a decantation vessel 21, the clarified flow is separated from the quenched pyrolysis fluid by removing fluid with a specific gravity less than a threshold. This threshold can be selected based on the desired composition of the clarified flow. For example, the threshold may be 0.9.

The separation apparatus separates the quenched pyrolysis fluid to produce a clarified flow. The method then further comprises selectively bleeding-off a bleed-off portion of the clarified flow via a bleed-off line 50. The clarified flow is cooled with cooling apparatus 30 to produce a cooled clarified flow. This cooled clarified flow may be cooled to less than 50° C. At least a recirculation portion of the clarified flow is returned to the quenching vessel 10 via a recirculation line 40.

Flow control apparatus 60 may control flow into the bleed-off line 50 such that a volumetric rate of flow through the bleed-off line 50 is less than a volumetric rate of flow of back to the quenching vessel 10.

A plurality of processes may be operated with out-of-phase duty cycles. This may be, for example, out-of-phase pyrolysis units. The output from each of these processes can then be supplied to the quenching vessel 10 as one or more fluid streams.

The system 100, particularly the recirculation loop, may be operated continuously. This for example may mean that the steps of condensing the fluid stream, expelling the quenched pyrolysis fluid, separating the quenched pyrolysis fluid and returning the clarified flow are performed continuously.

The method can include the step of continuously expelling fluid from a lower portion of the decantation vessel 21 and returning this fluid back to the decantation vessel 21. This circulates fluid around the vessel 21 to thereby prevent material building up in the vessel and clogging.

Fluid with a specific gravity greater than the threshold can be removed from the decantation vessel 21 and transported to a secondary decantation vessel 71, such as described above. This secondary decantation vessel 71 can then be used to separate wastewater from the removed fluid, again as described above.

This secondary decantation vessel 71 can include a circulation to prevent clogging in the same manner as the first decantation vessel 21. This involves continuously expelling fluid from a lower portion of the secondary decantation vessel 71 and returning this fluid back to the decantation vessel 71.

The method may include priming the quenching vessel 10 by filling it with a pre-determined volume of fluid—such as water. Then, as pyrolysis fluid is introduced to the quenching vessel 10 the priming fluid is displaced and removed via the method steps discussed.

As noted, any of these method steps can be used with any of the systems 100 described above. Likewise, the methods can be used with any other systems 100.

1. A system for removing contaminants from a pyrolysis fluid comprising:
a recirculation loop comprising:
a quenching vessel having:
a first inlet for receiving a supply of pyrolysis fluid;
a second inlet arranged to receive a recirculated fluid; and
an outlet for expelling quenched pyrolysis fluid;
separation apparatus for removing contaminants from the quenched pyrolysis fluid to provide a clarified flow, the separation apparatus arranged to receive quenched pyrolysis fluid from the outlet; and
a recirculation line arranged to receive at least a recirculation portion of the clarified flow and recirculate the recirculation portion to the second inlet; and
cooling apparatus arranged to cool fluid in the recirculation loop; and
a bleed-off line for selectively bleeding-off a bleed-off portion of the clarified flow from the recirculation loop.

2. The system of claim 1, further comprising flow control apparatus arranged to control flow through the bleed-off line such that a volumetric rate of flow through the bleed-off line is less than a volumetric rate of flow through the recirculation line.

3. The system of claim 2, wherein the volumetric rate of flow through the bleed-off line is at most 30% of the volumetric rate of flow through the recirculation line.

4. The system of claim 2, further comprising a controller arranged to control the flow control apparatus to control flow through the bleed-off line.

5. The system of claim 4, wherein the controller controls the flow control apparatus based on one or more of:
a volumetric rate of flow into the separation apparatus; or
a volume of fluid in the quenching vessel or the separation apparatus.

6. The system of claim 4, wherein the controller is arranged to control the flow control apparatus to control flow through the bleed-off line such that the volumetric rate of flow through the recirculation line is substantially constant.

7. The system of claim 4, further comprising a pump arranged to pump the quenched pyrolysis fluid from the outlet to the separation apparatus, wherein the controller is further arranged to control the pump.

8. The system of claim 7, wherein the controller is arranged to control the pump such that the volumetric rate of flow through the recirculation line is substantially constant.

9. The system of claim 1, wherein the separation apparatus further comprises a filter between the separation apparatus and the recirculation line.

10. The system of claim 1, wherein the bleed-off line further comprises secondary separation apparatus for filtering flow through the bleed-off line.

11. The system of claim 1, wherein the quenching vessel comprises a quench column.

12. The system of claim 1, wherein the separation apparatus comprises a decantation vessel.

13. The system of claim 12, wherein the decantation vessel comprises an outlet, and the separation apparatus further comprises a return line arranged to return fluid expelled from the outlet back to the decantation vessel.

14. The system of claim 13, further comprising a discharge line arranged to selectively discharge fluid expelled from the outlet to a secondary decantation vessel for removing wastewater.

15. The system of claim 14, further comprising:
discharge flow control apparatus arranged to control flow through the discharge line; and
a discharge controller arranged to control operation of the discharge flow control apparatus based on a level of contamination of the supply of pyrolysis fluid.

16. The system of claim 14, wherein the secondary decantation vessel further comprises an outlet, and the secondary decantation vessel further comprises a return line arranged to return fluid expelled from the outlet back to the secondary decantation vessel

17. The system of claim 16, further comprising a second discharge line arranged to selectively discharge fluid expelled from the outlet of the secondary decantation vessel to third separation apparatus arranged to receive discharged fluid for removing solids from the discharged fluid.

18. The system of claim 14, wherein the bleed-off line comprises a third discharge line arranged to discharge at least a portion of the bleed-off portion to the secondary decantation vessel apparatus.

19. The system of claim 1, wherein the quenching vessel is arranged to receive a plurality of fluid streams from a plurality of processes out-of-phase with one another, preferably one or more of the fluid stream is a recovered pyrolysis oil stream.

20. A method of removing contaminants from a pyrolysis fluid, the method comprising the steps of:
supplying the pyrolysis fluid to a quenching vessel;
quenching the pyrolysis fluid in the quenching vessel to form a quenched pyrolysis fluid;
expelling the quenched pyrolysis fluid from the quenching vessel to separation apparatus;
separating, with the separation apparatus, the quenched pyrolysis fluid to produce a clarified flow;
selectively bleeding-off a bleed-off portion of the clarified flow via a bleed-off line;
cooling at least a portion of the clarified flow with cooling apparatus to produce a cooled clarified flow; and
returning at least a recirculation portion of the clarified flow to the quenching vessel via a recirculation line.

21. The method of claim 20, further comprising the step of:
controlling with a flow control apparatus flow into the bleed-off line such that a volumetric rate of flow through the bleed-off line is less than a volumetric rate of flow of back to the quenching vessel.

22. The method of claim 20, further comprising the steps of:
operating a plurality of processes out-of-phase from one another;
supplying an output of each of the processes to the quenching vessel as the one or more fluid streams.

23. The method of claim 20, wherein the steps of condensing the fluid stream, expelling the quenched pyrolysis fluid, separating the quenched pyrolysis fluid and returning the clarified flow are performed continuously.

24. The method of claim 20, wherein the quenching vessel operates at between 40° C. and 300° C.

25. The method of claim 20, wherein the portion of the clarified flow is cooled to less than 50° C.

26. The method of claim 20, wherein the separation apparatus is a decantation vessel and the clarified flow is separated from the quenched pyrolysis fluid by decanting fluid with a specific gravity less than a threshold from the decantation vessel as the clarified flow.

27. The method of claim 26, wherein the threshold is 0.9.

28. The method of claim 26, further comprising the step of continuously expelling fluid from a lower portion of the decantation vessel and returning this fluid back to the decantation vessel.

29. The method of claim 26, further comprising the steps of:
removing fluid with a specific gravity greater than the threshold from the decantation vessel; and
separating, with a secondary decantation vessel, the removed fluid to remove wastewater therefrom.

30. The method of claim 29, further comprising the step of continuously expelling fluid from a lower portion of the secondary decantation vessel and returning this fluid back to the decantation vessel.
